(19) United States
(12) Patent Application Publication
(10) Pub. No.: US 2005/0149432 A1
(43) Pub. Date: Jul. 7, 2005

(54) System and method of online real estate listing and advertisement

(76) Inventor: Mark Galey, McDonough, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/896,331

(22) Filed: Jul. 21, 2004

Related U.S. Application Data
(60) Provisional application No. 60/488,776, filed on Jul. 21, 2003.

(51) Int. Cl. G06F 17/60

(52) U.S. Cl. 705/38; 705/1

(57) ABSTRACT

A system and method for online real estate listing and advertisement, wherein the present invention provides real estate buyers, sellers, rental property owners and/or investors with the ability to purchase notification rights or leads to a variety of real estate activities generated within a selected geographic region. In addition thereto, the present invention provides a real estate identification number for accessing a global networking system website having details and photographic images of the associated property, thereby providing prospective buyer, investors and/or renters with convenient and continuous access to detailed information necessary to make an informed, yet expeditious, real estate transaction.

### CROSS-REFERENCE AND PRIORITY CLAIM TO RELATED APPLICATIONS

To the fullest extent permitted by law, the present nonprovisional patent application claims priority to and the full benefit of provisional patent application entitled “APPARATUS AND METHOD FOR ONLINE RENTAL LISTING AND ADVERTISEMENT”, filed on Jul. 21, 2003, having assigned Ser. No. 60/488,776.

### COPYRIGHT NOTICE AND LIMITED AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates generally to methods of real estate sale and advertisement, and more specifically to a system and method of online real estate listing and advertisement. The present invention is particularly suitable for, although not strictly limited to, providing a subscription-based advertising forum for the online listing of real property, wherein subscribing members are able to view and/or list homes or properties for rent and/or sale, receive property details and visual images on other listed properties, and have direct contact with the property owners and/or prospective buyers/renters thereof via an associated online real estate identification number and searching system.

### BACKGROUND OF THE INVENTION

Prospective renters and homebuyers are often presented with limited time and minimal resources in which to seek a home or other property in confluence with their lifestyle and associated demands. Ironically, property owners seeking to rent or sell their property are often unable effectively market their property to such prospective renters, buyers, or the real estate market in general, and therefore, are typically unable to procure a renter or buyer within a desired period of time.

Additionally, individual or small-scale property owners seeking to market their property to prospective renters or buyers are often unable to successfully compete with large corporations specializing in real estate services (i.e., buying, selling and renting of real property), as many such corporations typically have large marketing and advertising budgets that facilitate targeting and attracting a larger prospective consumer base. As such, although individual or small-scale property owners may have an enticing piece of real estate, and because large-scale targeted marketing is generally not an available option, such property owners are incapable of procuring the “easy” sales; that is, the selling or renting of property to eager prospective buyers or renters, respectively, having limited search time and options.

Moreover, because such property owners and prospective renters/buyers are inherently absorbed by the demands of their respective lifestyles, arranging a convenient time to meet, discuss property details, and view the property itself, can be difficult. Unfortunately, even if an appointment or other arrangement is made to gather such information and view the property, most real property owners often experience “no-shows” or last-minute cancellations. Although such “no-shows” or cancellations may be attributed to unforeseen occurrences, most are more aptly attributed to the inconvenience the prospective renter/buyer may feel in having to manipulate his/her daily schedule to view the property, often deciding that viewing the property is not worth the trouble or inconvenience. Instead, most prospective renters/buyers will typically turn to the more easily accessible large corporate-owned rental/purchase properties, even at the sacrifice of having to pay more for an overall smaller piece of property.

Essentially, most prospective consumers seek convenience in making their purchase endeavors, and will likely pay more for same, rather than expending personal time shopping for the best deal. The result, unfortunately, is that property owners who cannot conveniently and expeditiously provide prospective renters/buyers with the desired information (i.e., cater to the needs of the consumer), are often left with unoccupied residences and, potentially, an additional mortgage payment.

Moreover, although telephone information retrieval methods utilizing a central database of audible recordings are available for describing the amenities of a piece of real property, such systems are disadvantageous, as they do not provide the user with a visual image of the property or its surroundings. Such visual images are typically only available to real estate agents, and are often only made available to prospective renters, buyers, or the like, upon establishing a formalized relationship or agreement between themselves and the agent.

An additional concern amongst real estate investors, sellers, and rental property owners alike, is the quality or level of seriousness of the interested seller, buyer, or renter, as the time and money expended in advertising real property can become overwhelming if quality or serious sellers, buyers, or renters is severely lacking. That is, the goal of most real estate investors, sellers, and rental property owners, is to procure a fast and easy transaction from serious sellers, buyers, or renters so as to avoid the expense and time of ongoing advertisement efforts. Unfortunately, there is currently no effective and efficient method of “weeding out” such poor quality sellers, buyers, or renters, and, as such, many real estate investors, sellers, and rental property owners must often entertain each lead or interested person to avoid missing, or dismissing, the serious seller, buyer, or renter.

Therefore, it is readily apparent that there is a need for a system and method of online, subscription-based, real estate listing and advertisement, wherein property owners (i.e., subscribing members) are able to cost-efficiently provide prospective renters and/or buyers with a convenient, on-demand, on-line method of researching and viewing real property via an associated identification number and system. There is a further need for such a system and method, wherein prospective homebuyers and/or real estate investors may subscribe to the online real estate services of the present invention in an effort to seek interested sellers of real property. There is still a further need for such a system and method, wherein prospective real estate buyers, sellers, rental property owners and/or investors may subscribe to geographically-defined advertising forums, and receive leads to particular properties offered for rent, sale, or investment, located within such forums, and wherein such leads may be viewed and studied prior to expending additional time and effort in pursing the sale, buy, or rental offered therethrough.

### BRIEF SUMMARY OF THE INVENTION

Briefly described, in a preferred embodiment, the present invention overcomes the above-mentioned disadvantages and meets the recognized need for such an invention by providing a system and method of online real estate listing and advertisement, wherein property owners provide prospective investors, buyers, and/or renters with a property identification number for accessing a global networking system website having details and photographic images of the associated real property, thereby providing such prospective investors, buyers and/or renters with convenient, 24-hour access to detailed information necessary to make an informed, yet expeditious, rental/purchase decision. The present invention further provides real estate buyers, sellers, rental property owners and/or investors with subscription-based access to leads regarding interested sellers, buyers or renters within a subscribed geographical area, wherein such leads may be analyzed, and the value thereof assessed, prior to the real estate buyers, sellers, rental property owners and/or investors expending additional time and effort in pursing the sale, buy, or rental offered therethrough.

According to its major aspects and broadly stated, the present invention in its preferred form is a system and method of online real estate listing and advertisement, having, in general, a lead generation system, a lead purchase process, yard signs, real property identification numbers, and associated real property information and images accessible via a global networking system.

More specifically, the present invention is a system and method of subscription-based online real estate listing and advertisement, wherein subscribing members, including real estate sellers, buyers, investors and/or rental property owners preferably subscribe and purchase notification rights or leads to a variety of real estate activities generated within a selected geographic region.

Preferably, leads are generated by prospective buyers, sellers, and renters, which may include subscribing members, completing an online form available through a main website offering the present system and method. Such forms may include “seeking to sell a home” form, “seeking to buy a home” form, “seeking to offer a home for rent” form, and/or “seeking to rent a home” form. Following completion and submittal of an applicable form through the website, all data or information is preferably compared against a database of subscribing members and each member's purchased notification rights or leads in a particular geographic area.

For instance, assuming a “seeking to buy a home” form was completed and submitted, and the form indicated that the prospective homebuyer was seeking to purchase a property in Cobb County, Ga., all members who purchased “buy” leads within the geographic area of “Cobb County, Ga.,” would receive this “buy” lead or notification via electronic mail, or other similar expedited notification process. Thereafter, a subscribing member may access the main website, log into his/her account, and access details regarding the particular lead.

Generally, and with regard to the foregoing example, the lead, at least initially, provides the member with the notification that a homebuyer is seeking to purchase a piece of property within Cobb County Georgia, but will not expound upon the homebuyer or details of the homebuyer's wants and needs. Accordingly, a member may elect to purchase the lead without further detail, but at a reduced price, and thus, risk, solely on the lead as presented, the viability or success of a real estate transaction between him/herself and the prospective homebuyer. Alternatively, the member may elect to pay a higher price for the lead, and thus receive additional information and detail about the lead so as to make a more informed decision on the viability, success or value of same, and the ensuing transaction with the prospective homebuyer. Similar processes are followed for “sell” leads and “rent” leads.

In an effort to facilitate the above-described lead generation and purchase process, and in an effort to further advertise each member's real property as advertised through the main website, yard signs having real estate property identification numbers are preferably placed upon each of the member's property premises, wherein the identification numbers are preferably utilized to access an online information database associated with each particular piece of real property, and to permit generation of leads through the website. Preferably, a prospective investor, buyer or renter, upon discovering the property, obtains the identification number from the yard sign and enters the identification number into a website search engine or data entry field located on the main website. Preferably, the identification number permits the prospective investor, buyer or renter to gain online access to detailed information about the property, such as, for exemplary purposes only, property amenities, sales/rent amount, security deposits, lease terms, length of tenancy, location, map and driving directions, surrounding businesses, surrounding roadways and highways, similar demographics and the like. Additionally, the prospective buyer or renter may also access a database of digital images of the property, including, but not limited to, front yard, back yard, landscape, bedrooms, bathrooms, living areas, basement, surrounding properties, and the like. Preferably, the present signage system facilitates the sales or rental process for both the property owner and the prospective investor, buyer, or renter, by harmonizing a mutual arena or online meeting place for the exchange of desired information, thereby making the purchase or rental process highly convenient for the prospective investor, buyer, or renter, and a cost-efficient means of real property marketing for the property owner.

Accordingly, a feature and advantage of the present invention is its ability to more effectively advertise, target and market toward prospective investors, buyers or renters seeking immediate detailed information about a piece of property.

Another feature and advantage of the present invention is its ability to provide real estate buyers, sellers, rental property owners and/or investors with the ability to purchase notification rights or leads to a variety of real estate activities generated within a selected geographic region.

Still another feature and advantage of the present invention is its ability to provide prospective investors, buyers or renters with detailed information about a piece of real property prior to entering a purchase, rental or lease agreement for same.

Yet another feature and advantage of the present invention is its ability to enable property owners to effectively, and without excessive burden and cost, provide the prospective buyers and renters market with continuously updated real property information.

Still yet another feature and advantage of the present invention is its ability to provide property owners with effective marketing and advertising of their properties within a certain geographic region.

A further feature and advantage of the present invention is its provision of an identification number for convenient and expeditious online access to detailed digital images and/or photographs of the associated real property.

Still a further feature and advantage of the present invention is its provision of an identification number for convenient and expeditious online access to detailed real property information, including, but not limited to, purchase information, sales information, rental terms, demographics, and/or the like.

Yet a further feature and advantage of the present invention is its ability to permit prospective buyers and renters to conveniently and expeditiously locate a home, or other property, in confluence with their lifestyle and associated demands without undue searching and/or inconvenient manipulation of daily regimes.

Still yet a further feature and advantage of the present invention is its ability to permit prospective investors, buyers, and/or renters to directly contact property owners for exchange and/or receipt of any information needed to facilitate the real estate transaction process.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a flow diagram of lead generation system of a system and method of online real estate listing and advertisement according to a preferred embodiment of the present invention;

FIG. 2 is a diagrammatic presentation of a lead notification bulletin offered through a system and method of online real estate listing and advertisement according to a preferred embodiment of the present invention;

FIG. 3 is a front view of a sign of a system and method of online real estate listing and advertisement according to a preferred embodiment of the present invention; and,

FIG. 4 is an illustration of a graphical user interface for a global networking system of a system and method of online real estate listing and advertisement according to a preferred embodiment of the present invention.

### DETAILED DESCRIPTION OF THE PREFERRED AND ALTERNATIVE EMBODIMENTS

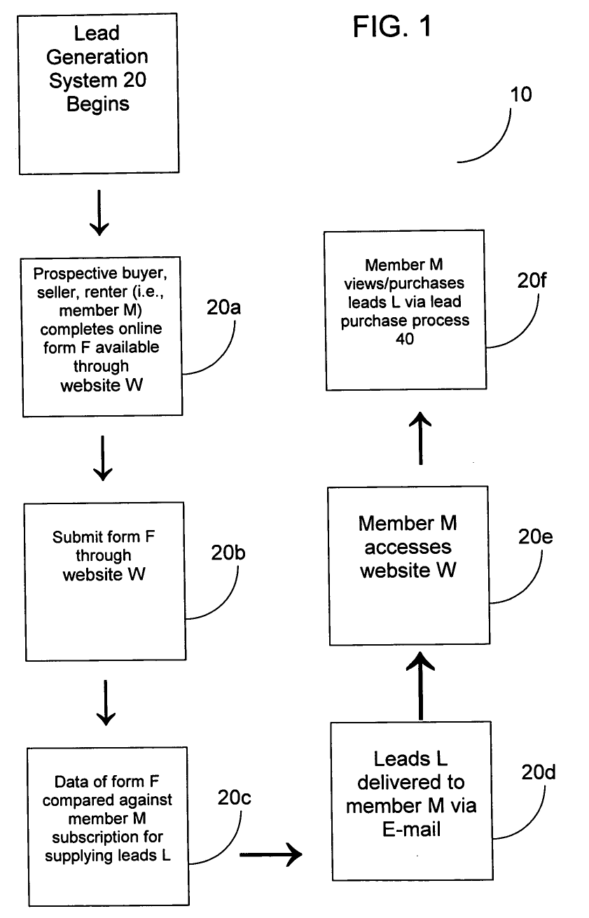

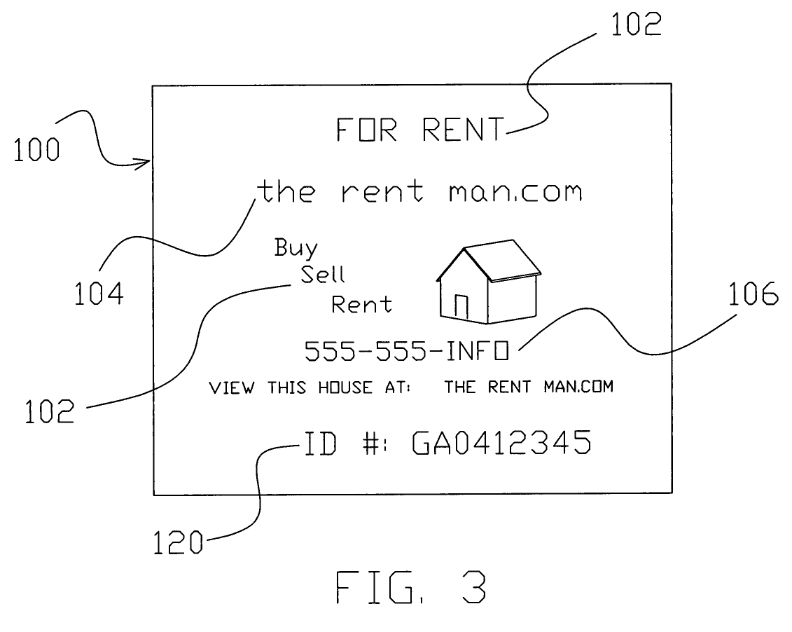

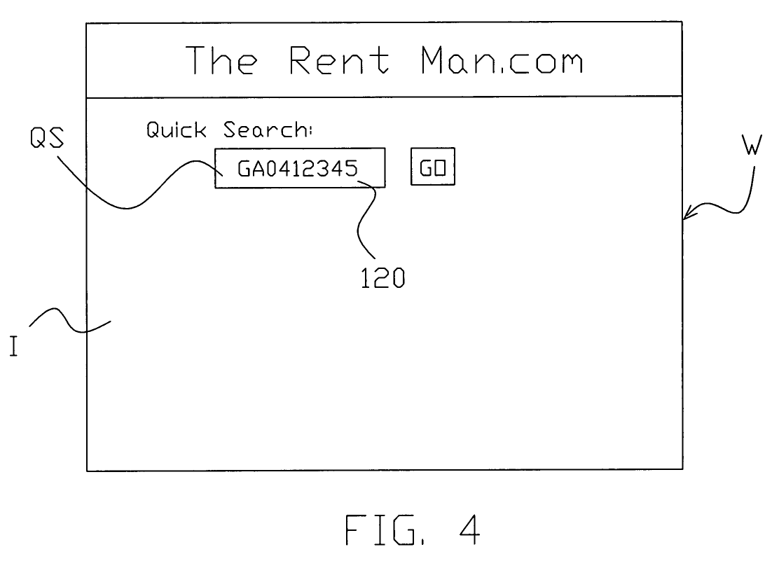

In describing the preferred and alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, the present invention in a preferred embodiment is a system and method 10 of online real estate listing and advertisement, comprising lead generation system 20 and lead purchase process 40, each preferably implemented through website W providing system and method 10. As more fully described below, subscribing members M of system and method 10, including real estate sellers, buyers, investors and/or rental property owners, preferably subscribe and purchase notification rights or leads to a variety of real estate activities generated within a selected geographic region. In conjunction with lead generation system 20 and lead purchase process 40, system and method 10 further comprises yard signs 100, real property identification numbers 120, and associated real property information and images accessible through website W.

Preferably, system and method 10 is a subscription-based service, wherein subscribing members M, such as real estate sellers, buyers, investors, and rental property owners alike, preferably subscribe to the services of system and method 10, through website W, to advertise their various real property interests to prospective buyers, sellers and/or renters, as applicable. Subscribing members M preferably remit subscription fees, or the like, through website W. Preferably, each member M may further purchase, through website W, notification rights or leads to real estate inquiries and activities generated within a selected geographic area via leads generation system 20, as more fully described below. As such, members M may receive inquires from prospective sellers, buyers and/or renters seeking to buy, sell, and/or rent, respectively, real property within a subscribed geographic area.

Referring now more specifically to FIG. 1, step 20a of lead generation system 20 is preferably implemented upon a prospective buyer, seller, and/or renter, which may include subscribing members M, completing online form F available through website W, wherein form F may be, without limitation, a “seeking to sell a home” form, a “seeking to buy a home” form, a “seeking to offer a home for rent” form, and/or a “seeking to rent a home” form. Following completion and submittal (step 20b) of an applicable form F through website W, all data or information entered therein is preferably compared against a database of subscribing members M and each member M's purchased notification rights or leads in a particular geographic area (step 20c).

For instance, assuming a “seeking to buy a home” form F was completed and submitted, and form F indicated that the prospective homebuyer was seeking to purchase a property in Cobb County, Ga., all members M who purchased “buy” leads L within the geographic area of “Cobb County, Ga.,” would receive this particular “buy” lead L or notification via electronic mail, or other similar expedited notification process (step 20d). Thereafter, subscribing member M may access website W (step 20e), log into his/her account, and purchase and/or access details regarding lead L (step 20f) via lead purchase process 40, as more fully described below.

Preferably, similar processes are followed for “sell” leads L and “rent” leads L, wherein applicable forms F are completed and submitted through website W, and wherein the data/information thereof is provided to members M based upon the subscription type of each such member M. That is, members M may selectively purchase/subscribe to, either individually or in combination, “buy” leads L, “sell” leads L, “rent” leads L and/or the like, within a defined geographic area, or within several defined geographic areas. Accordingly, the provision of leads L to members M pursuant to step 20f of leads generation system 20, is based upon the parameters or scope of each member M's subscription (i.e., the type of leads L of each member M's subscription).

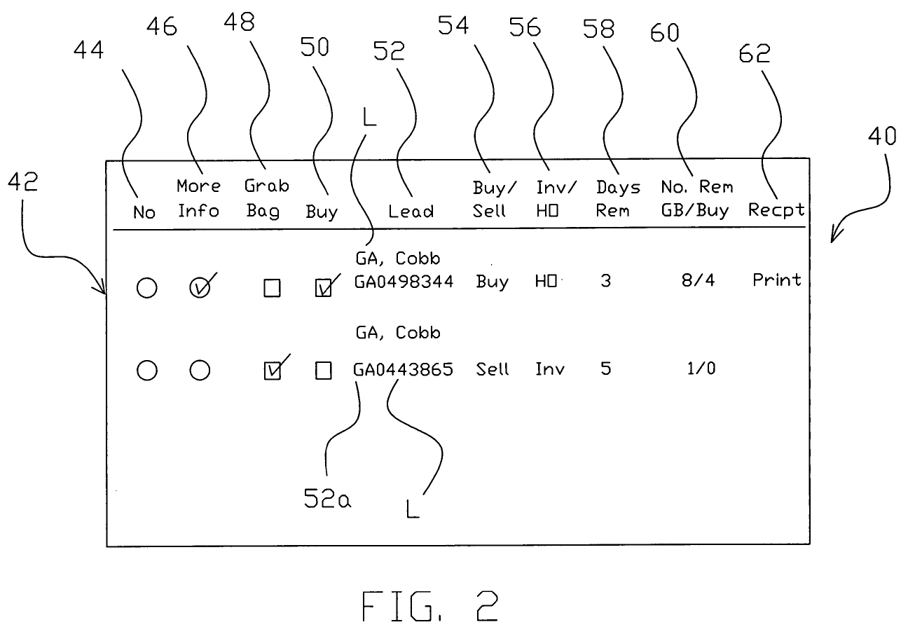

Referring now more specifically to FIG. 2, with continued reference to FIG. 1, and in keeping with the foregoing example, upon accessing his/her account through website W, member M is presented with lead notification chart or bulletin 42 listing all available leads L, including “buy” lead L of the foregoing example. For each lead L generated through lead generation system 20 described hereinabove, bulletin 42 provides member M with several “clickable” or selectable options and/or descriptive headers, including “No” option 44 (selection of same results in no further action taken on lead L); “More Information” option 46 (selection of same results in member M being provided with some detailed or partial information about lead L, but at a higher price than the “grab bag” price, described hereinbelow); “Grab Bag” option 48 (selection of same results in member M purchasing lead L at a lower price, but without any detail regarding lead L); “Buy” option 50 (must be selected if “More Information” option 46 is selected and if member M wishes to buy lead L and receive complete details regarding same); “Lead” option 52 (describes the geographic origination of lead L, typically grouped by county and state, wherein selection of same results in the display of any detail that might be available to member M at that particular time); “Buy/Sell” header 54 (indicates the type of lead L generated—“buy” lead, “sell” lead, or “rent” lead); “Investor/Homeowner” header 56 (indicates whether lead L was generated by an investor or homeowner); “Days Remaining” header 58 (indicates how many days lead L is available for purchase before removal of same from member M's account); Number of Grab Bags/Buys Remaining“header 60 (indicates the number of remaining grab bags to the number of remaining buys available for a particular lead L, as other subscribing members M may have also purchased this particular lead L); and, “Receipt” option 62 (selection of same results in member M being provided with a printout of the purchased lead(s) L). For each lead L listed under “Lead” option 52, a lead ID 52a is provided therewith, wherein lead ID 52a preferably comprises a State Code, the current year and a random 5-digit number (i.e., GA0498344); however, any selected codification method may be utilized.

Accordingly, with regard to the foregoing “Cobb County, Ga.” “buy” lead L, bulletin 42, at least initially, provides member M with notification of the geographic origination of lead L via “Lead” option 52; that “buy” lead L is indeed a “buy” lead, as indicated via “Buy/Sell” header 54; that “buy” lead L originates from a homeowner, as indicated via “Investor/Homeowner” header 56; that “buy” lead L is available for purchase for three days, as indicate via “Days Remaining” header 58; and, that eight “grab bags” to four “buys” remain available for this particular “buy” lead L, as indicated via “Number of Grab Bags/Buys Remaining” header 60, wherein the relevancy of the foregoing 8/4 grab bags/buys ratio is more fully described below.

Additionally, in the present example, member M has selected “More Information” option 46 for access to some detailed or partial information about “buy” lead L; thus, enabling member M to make a slightly more informed decision on the viability, success or value of same, and the ensuing transaction with the prospective homebuyer. As such, member M, in purchasing “buy” lead L, must now select “Buy” option 50, as indicated on bulletin 42, and must pay price X for same, wherein price X is a higher value than the price that would otherwise be paid for “buy” lead L if purchased as a “grab bag” via “Grab Bag” option 48, as more fully described below. Upon selecting “Buy” option 50, and thus purchasing “buy” lead L, member M will receive complete details regarding same.

With continued reference to bulletin 42 of FIG. 2, and regarding the “Fulton County, Ga.” “sell” lead L listed thereon, member M, at least initially, is provided with notification of the geographic origination of “sell” lead L via “Lead” option 52; that “sell” lead L is indeed a “sell” lead, as indicated via “Buy/Sell” header 54; that “sell” lead L originates from an investor, as indicated via “Investor/Homeowner” header 56; that “sell” lead L is available for purchase for five days, as indicate via “Days Remaining” header 58; and, that one “grab bag” to zero “buys” remain available for this particular “sell” lead L, as indicated via “Number of Grab Bags/Buys Remaining” header 60, wherein the relevancy of the foregoing 1/0 grab bags/buys ratio is more fully described below.

As such, in the foregoing “sell” lead L example, member M has selected “Grab Bag” option 48 and, as such, has purchased “sell” lead L at a “grab bag” price Y, wherein price Y is a lower value than price X that would have otherwise been paid for “sell” lead L if “More Information” option 46 was selected, and thus, “Buy” option 50 to purchase “sell” lead L. If member M purchases “sell” lead L, or other leads L, at “grab bag” price Y, member M is basing the purchase of same solely on lead L as presented, and thus, risks the viability or success of a real estate transaction between him/herself and the prospective homebuyer on same. Essentially, purchasing leads L via “Grab Bag” option 48, and at the “grab bag” price Y, is, at least initially, a “blind” purchase. However, once the “grab bag” purchase transaction is completed, member M will receive complete details regarding “sell” lead L.

With regard to “Days Remaining” header 58, each lead L is available for purchase to subscribing members M for a period of 14 days; that is, each lead L preferably has a 14 day “shelf-life”, wherein expiration of this 14 day shelf-life results in all applicable leads L being made available to all members M, including those who may have not subscribed to the geographic area from which such leads L were originally generated. Preferably, the shelf-life for each such lead L functions to provide the real estate advertising forum of the present system and method 10 with more expeditious real estate transactions, requiring members M to act quickly upon receiving a lead L so as to avoid expiration of the shelf-life of same, and thus, the availability and potential usurpation of same by other members M. Accordingly, the shelf-life of each lead L is intended to promote a sense of urgency and, thereby, maintain the integrity, value, and purpose of lead generation system 20, lead purchase process 40, and leads L, in general.

The present invention further contemplates that if a lead L is generated from a geographic area in which no member M currently holds a subscription, then such a lead L will be made available to all members M for a period of 6 months, or any other selected period of time. However, if, during the 6 month period, a member M purchases or subscribes to the geographic area from which the afore-referenced lead L was generated, then such a lead L will be made available exclusively to member M, for the prescribed 14-day period.

With regard to “Number of Grab Bags/Buys Remaining” header 60, and the relevancy of the grab bags/buys ratio thereunder, each lead L preferably comprises a grab bags/buys ratio of 1:2, wherein a fractional number for a grab bag will be reduced to the next whole number (i.e., a grab bag value of 9.5 will be reduced to 9). Accordingly, at the time of each lead L's generation, each lead L preferably offers 10 grabs bags/20 buys. If 1 grab bag of lead L is purchased, the available ratio would be reduced to 9 grabs bags/18 buys; if 1 buy of lead L is purchased, the available ratio would be reduced to 9 grabs bags/19 buys; if 2 buys of lead L are purchased, the available ratio would be reduced to 9 grabs bags/18 buys—and so forth. The purpose of such a grab bags/buys ratio, and the associated method of reducing the ratio as described above, is to promote a sense of urgency in the mind of member M to act quickly the purchase of leads L and, thus, maintain the integrity, value, and purpose of lead generation system 20, lead purchase process 40, and leads L, in general.

In an effort to facilitate the above-described lead generation system 20 and lead purchase process 40, and in an effort to further advertise each member M's real property as advertised through website W, the present system and method 10 preferably provides each member M with a yard sign 100 for each of member M's property advertised through website W, wherein each yard sign 100 preferably comprises identification number 120, as more fully described below, for purposes of accessing associated property information and images through website W, and for purposes of generating and referencing leads L, as described above.

Specifically, sign 100 is preferably in the form of a conventional yard sign; however, other advertising mediums could be utilized such as, for exemplary purposes only, residential window signs, banners, flyers, brochures, pamphlets, signs for car windows, or the like. Preferably disposed on sign 100 is indicia 102, wherein indicia 102 preferably recites the words “FOR RENT”, “FOR SALE”, “RENT”, “SELL”, and/or “BUY”, to appropriately designate and relay the property owner's property status and intent to rent, sell, or otherwise transact for same. Sign 100 further preferably possesses website address 104 for purposes of providing the prospective buyer or renter with the appropriate online address to website W in which to retrieve all applicable information regarding the property, as more fully detailed below. Preferably, to facilitate immediate name and service brand recognition, website address 104 is preferably in the form of the trademark “THE RENT MAN.COM,” although other suitable website addresses could be utilized. Sign 100 further preferably possesses phone number 106 for procuring telephone-based information on the property. Additionally, identification number 120 is preferably conspicuously displayed on sign 100, wherein identification number 120 is preferably utilized to gain online access to detailed information and digital photographic images of the associated real property, and wherein such information is preferably retrieved via website W, as more fully described below.

Preferably, a property owner places sign 100 upon his/her property premises, wherein a prospective buyer or renter, upon discovering the property, preferably obtains identification number 120 from sign 100. Thereafter, the prospective buyer/renter preferably accesses website W via a global networking system and enters identification number 120 into a “quick search” data retrieval field QS on graphical user interface I of website W. Identification number is preferably similar to lead ID 52a; however, other suitable codification systems may be utilized.

Preferably, cuing in identification number 120 into data retrieval field QS permits the prospective buyer or renter to gain online access to detailed information about the property, such as, for exemplary purposes only, property amenities, purchase/rent amount, security deposits, lease terms, length of tenancy, floor plans, location, map and driving directions, surrounding businesses, surrounding roadways and highways, local schools, local churches, similar demographics and the like. Additionally, the prospective buyer or renter may also access a database of digital colored photographic images of the property, including, but not limited to, front yard, back yard, landscape, bedrooms, bathrooms, living areas, basement, surrounding properties, and the like, thereby providing the prospective buyer or renter with a visual representation of the property to more confidently proceed with a rental/purchase arrangement.

Moreover, cuing in identification number 120 into data retrieval field QS further preferably provides the property owner with leads L from the prospective buyer or renter, thereby facilitating direct contact therebetween. Alternatively, the prospective buyer or renter may access website W and, through lead generation system 20 described hereinabove, simply inquiry into the relevant property and/or similar properties located proximate thereto; thus, creating leads L upon which subscribing members M may act.

Preferably, it should be recognized that entry of identification number 120 into “quick search” data retrieval field QS provides the prospective buyer/renter with access only to the associated real property, and not any other property; thus, providing the property owner (i.e., member M) with a form of concentrated advertising.

It should further be recognized that website W preferably provides a prospective buyer, seller, investor, rental property owner, and/or renter, with 24-hour, 7-days a week, continuous access, thereby personalizing the real property search time to better accommodate the daily regime and lifestyle of the searcher. Such a method further preferably reduces and/or eliminates “no-shows” and/or last-minute canceled appointments often experienced by real property owners in an attempt to show their property, as the prospective buyer, investor or renter is now provided with a visual depiction of the property and all associated information prior to arranging an in-person walk-through of the property. Essentially, prospective buyers, sellers, investors, rental property owners, and/or renters, are able to search for available real estate and/or real estate inquiries at their convenience, leisure and pace via utilization of website W, and system and method 10 in general.

Although website W preferably provides “quick search” data retrieval field QS for retrieving a single real estate listing per identification number 120, it is contemplated in an alternate embodiment that multiple commonly-owned listings could be retrieved per identification number 120. It is contemplated in an additional alternate embodiment that a prospective buyer or renter could access website W and conduct a general property search to retrieve any and all property available for sale or rent, respectively.

It is contemplated in an alternate embodiment that website W could provide a new homebuyer with options to buy real property, wherein such an embodiment is utilized where a potential buyer is unable to otherwise purchase a home due to poor credit, no credit, insufficient or no down-payment, or the like, and wherein the property owner/seller actually finances and sets the terms and conditions of the sale. Specifically, sellers could list their property on website W, wherein sellers could make available to potential buyers several options such as, for exemplary purposes only, lease/purchase, rent-to-own, owner financing, financed down payment, flexible terms and conditions, expeditious and easy closing processes, low down-payment opportunities, arrangements with mortgage lenders, and options to eliminate real estate agent commissions. It is further contemplated that such an embodiment could be utilized by sellers experiencing difficulty in selling their property, wherein making available the aforementioned options to prospective buyers functions to increase potential sale of the seller's property.

It is contemplated in yet another alternate embodiment that website W could be utilized to assist a certain portion of the public in selling their homes in an effort to regain financial stability, build equity, avoid and/or stop foreclosures, and/or pay back a mortgage lender. In such an embodiment, investors, providing services through website W, could assist such individuals by purchasing their property in situations involving job transfers, job relocations, estate settlements, downsizing, tired landlord, late or default payments, pre-foreclosures, foreclosures, tax liens, divorce, personal injury, excessive financial property repairs, and/or a desire to sell unsightly or aesthetically pleasing homes.

It is contemplated in still another alternate embodiment that the present system and method could provide members M with exclusive notification or referrals to leads L within a specific geographic area based upon a first-to-order or first-to-subscribe, wherein subsequent subscribing members M may receive notification of such leads L only after the first subscribing member M elects to not purchase same.

It is contemplated in still another alternate embodiment to incorporate a system of governing, and accordingly deactivating, the subscription of a member M against whom complaints have been lodged.

It is contemplated in yet another alternate embodiment that website W could entail the use of partnership websites, wherein website W could display a link to the partnership website in exchange for a reciprocal link on same, thereby increasing the marketing and advertising forum. Such partnership websites could include, but would not be limited to, financial lenders, moving companies, mailing and parcel companies, storage companies, utility companies, and the like.

In yet another alternate embodiment it is contemplated that the subscription period for use of website W in any of the preferred and/or alternate embodiments as described above could incorporate an auto-reminder process that would entail electronically mailing a subscription renewal reminder to member M/property owner, such as four months and/or two months prior to expiration of the subscription.

In still another alternate embodiment, it is contemplated that website W could incorporate a rewards system, wherein prospective renters could receive payment for a portion of their rental term or lease term on property found through website W.

It is contemplated in yet another alternate embodiment that website W could incorporate a “guestbook” encouraging prospective buyers, sellers, renters and/or other users of website W to enter in their name and E-mail address for purposes of receiving promotional material and/or rewards through website W such as, for exemplary purposes only, priority notification of new listings, free rent incentives, educational materials, available services, new services, private investor pages, and/or industry related website links.

In yet another alternate embodiment it is contemplated that sign 100 could possess indicia other than indicia 102, such as, for exemplary purposes only, “FOR SALE,” “LEASE/PURCHASE,” and/or “RENT-TO-OWN.”

In yet another alternate embodiment it is contemplated that sign 100 could possess a plurality of identification numbers 120 for directing prospective buyers, investors and/or renters to complimentary or similar, perhaps commonly-owned, properties.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A method of subscription-based online real estate listing and advertising, said method comprising the steps of:
a. providing members with access to an online real estate listing and advertising forum;
b. generating a real estate transaction lead of a first type;
c. providing access to said lead to said members having a lead subscription encompassing said lead of said first type:

2. The method of claim 1, wherein said first type of said lead is selected from a group consisting of buy leads, sell leads, rent leads, investment leads, buy leads originating from a defined geographic area, sell leads originating from a defined geographic area, rent leads originating from a defined geographic area, investment leads originating from a defined geographic area, and combinations thereof.

3. The method of claim 1, wherein said lead subscription is selected from a group consisting of buy leads, sell leads, rent leads, investment leads, buy leads originating from a defined geographic area, sell leads originating from a defined geographic area, rent leads originating from a defined geographic area, investment leads originating from a defined geographic area, and combinations thereof.

4. The method of claim 1, further comprising step d.: requesting more information about said lead.

5. The method of claim 4, further comprising step e.: buying said lead at a first price, said first price higher than a second price that would have otherwise been paid for said lead had said more information not been requested.

6. The method of claim 1, further comprising step d.: buying said lead without requesting more information about said lead.

7. The method of claim 6, further comprising step e.: buying said lead at a first price, said first price lower than a second price that would have otherwise been paid for said lead had more information been requested about said lead.

8. The method of claim 1, further comprising step d.: making said lead of said first type, for a prescribed period of time, available for purchase by said members having said lead subscription encompassing said lead of said first type.

9. The method of claim 1, further comprising step e.: providing access and purchase capabilities to said lead of said first type, following expiration of said prescribed period of time, to said members having a lead subscription encompassing leads other than said lead of said first type.

10. The method of claim 1, further comprising step d.: offering, at a first selected number of times, said lead for purchase by said members having said lead subscription encompassing said lead of said first type, wherein said first selected number of times permits said members to purchase said lead without requesting more information about said lead.

11. The method of claim 10, further comprising step e.: offering, at a second selected number of times, said lead for purchase by said members having said lead subscription encompassing said lead of said first type, wherein said second selected number of times permits said members to purchase said lead only after requesting more information about said lead.

12. The method of claim 11, wherein said first selected number of times and said second selected number of times is, at least initially, at approximately a 2:1 ratio.

13. The method of claim 11, wherein said first selected number of times and said second selected number of times remains at approximately a 2:1 ratio.

14. An apparatus for online real estate listing and advertising, said apparatus comprising:
at least one website address; and
at least one identification number for accessing information associated with the real estate listing via said at least one website address.

15. The apparatus of claim 14, wherein said apparatus comprises a real estate yard sign.

16. The apparatus of claim 15, wherein accessing said at least one website address with said at least one identification number generates a real estate transaction lead of a first type.

17. The apparatus of claim 16, wherein members are provided with access to an online real estate listing and advertising forum through said at least one website address.

18. The apparatus of claim 17, wherein members having a lead subscription encompassing said lead of said first type are provided with access to said lead.

19. A method of online real estate listing and advertisement, said method comprising the step of:
a. displaying, on a property premise, at least one website address and at least one identification number on a sign;
b. accessing said at least one website address via said at least one identification number to retrieve information specific to said property.

20. The method of claim 19, wherein said step of accessing said at least one website address with said at least one identification number generates a real estate transaction lead of a first type.

21. The method of claim 20, further comprising the step of c.: providing members with access to an online real estate listing and advertising forum through said at least one website address.

22. The method of claim 21, further comprising the step of d.: providing members having a lead subscription encompassing said lead of said first type with access to said lead.

23. The method of claim 22, wherein said first type of said lead is selected from a group consisting of buy leads, sell leads, rent leads, investment leads, buy leads originating from a defined geographic area, sell leads originating from a defined geographic area, rent leads originating from a defined geographic area, investment leads originating from a defined geographic area, and combinations thereof.

24. The method of claim 22, wherein said lead subscription is selected from a group consisting of buy leads, sell leads, rent leads, investment leads, buy leads originating from a defined geographic area, sell leads originating from a defined geographic area, rent leads originating from a defined geographic area, investment leads originating from a defined geographic area, and combinations thereof.
